(19) United States
(12) Patent Application Publication
(10) Pub. No.: US 2012/0015809 A1
(43) Pub. Date: Jan. 19, 2012

(54) Materials and Methods for Pest Control

(76) Inventors: Zhenli L. He, Fort Pierce, FL (US); Erin N. Rosskopf, Fort Pierce, FL (US); Youjian Lin, Fort Pierce, FL (US); Charles A. Powell, Fort Pierce, FL (US); Cuifeng Hu, Fort Pierce, FL (US); Fanny Iriarte, Fort Pierce, FL (US); Nancy Kokalis-Burelle, Fort Pierce, FL (US)

(21) Appl. No.: 13/144,039

(22) PCT Filed: Feb. 15, 2010
(86) PCT No.: PCT/US2010/024228

§ 371 Date: Oct. 4, 2011

Related U.S. Application Data
(60) Provisional application No. 61/153,485, filed on Feb. 18, 2009.

(51) Int. Cl. A01N 37/02; A01P 3/00; A01P 1/00; A01P 5/00; A01P 13/00

(52) U.S. Cl. 504/142; 514/557

(57) ABSTRACT

The subject invention provides materials and methods for the control of pests, including fungi, oomycetes, nematodes, and weeds, of numerous crops, plants and forests. Advantageously, pests in the soil can be controlled without phytotoxicity. In certain embodiments, the subject invention provides new pesticidal compositions. In preferred embodiments, these compositions comprise an active ingredient component that is formic acid and/or acetic acid, and/or salts thereof. The composition further comprises a second acidic component that enhances the pesticidal activity of the first active ingredient component.

### CROSS-REFERENCE. TO A RELATED APPLICATION

This application claims the benefit of U.S. provisional application Ser. No. 61/153,485, filed Feb. 18, 2009, which is incorporated herein by reference in its entirety.

### BACKGROUND OF INVENTION

Pests, including pathogenic fungi, oomycetes, bacteria, nematodes, and weeds, are detrimental to crops, forest, and other plants as they lead to growth rate problems, root problems and reductions in yield. Billions of dollars in losses occurs annually as a result of plant disease, nematode infestations and crop competition with weeds.

Methyl bromide is a highly effective fumigant used to control pests in more than 100 crops, in forests and ornamental nurseries, and in wood products. However, because of its ozone-depleting effect, methyl bromide is being phased out according to the Montreal Protocol. It is estimated that $1 billion are lost annually to the impacts of plant parasitic nematodes alone. It would thus be highly beneficial to have an effective and environmentally friendly alternative to methyl bromide.

Various compounds or combinations of compounds have been proposed as methyl bromide replacements to control soilborne pathogenic fungi, oomycetes, bacteria, nematodes, and weeds.

U.S. Pat. No. 7,282,212 discloses a method for controlling wood pests using a pesticide comprising at least a compound of thiamethoxam in free form or in the form of an agrochemically acceptable salt and at least one adjuvant.

U.S. Pat. No. 7,015,236 discloses a pesticide containing an n-heteroarylnicotinamide derivative or a salt as an active component and a method for producing it and intermediates.

U.S. Pat. No. 6,875,727 discloses a method for controlling pests with macrolide compounds.

U.S. Pat. No. 6,541,424 discloses a method for manufacture and use of herbicidal formulation containing the free acid form of glyphosate and an acid.

U.S. Pat. No. 6,294,584 discloses methods for fumigating soil containing deleterious organisms such as nematodes utilizing an effective amount of acrolein.

However, the pest-control methods of the prior art are often either too selective, i.e. they are only good for certain kinds of pests, or too non-selective meaning they also pose a threat to the environment, humans or animals that contact the pesticides. Therefore, there is a need for a non-toxic pesticide that can effectively suppress or kill pathogenic fungi, oomycetes, bacteria, nematodes, and/or weeds.

Formic acid is a well-known natural chemical produced by insects. It is registered by the EPA as a pesticide (MITE-AWAY II™, MITEGONE™) for the control of tracheal mites and varroa mites in honey bee hives (see U.S. Pat. No. 6,837,770). In addition, formic acid has been found to be an effective pre-emergent and post-emergent herbicide (US Published Patent Application, 2007/0281857). Acetic acid is also a broad-spectrum organic herbicide.

### BRIEF SUMMARY

The subject invention provides materials and methods for the control of pests, including fungi, oomycetes, bacteria, nematodes, and weeds, of numerous crops, plants and forests. Advantageously, pests in the soil can be controlled according to the subject invention without significant phytotoxicity to desired plants.

In certain embodiments, the subject invention provides new pesticidal compositions. In preferred embodiments, these compositions comprise an active ingredient component that is formic acid and/or acetic acid, and/or salts thereof. Formic acid is preferred as the active ingredient. The composition can further comprise a second acidic component that enhances the pesticidal activity of the first active ingredient component. The enhancing (or potentiating) component of the composition is preferably citric acid. As described herein, in certain embodiments the citric acid may be substituted by or mixed with other acids that may be, for example, selected from the group consisting of malic acid, oxalic acid, sulfuric acid, hydrochloric acid, and any combination thereof.

In preferred embodiments, the pesticidal compositions comprise formic acid in an amount between about 15% v/v and about 50% v/v and the citric acid in an amount between about 10% w/v and about 40% w/v.

In one embodiment specifically exemplified herein (and referred to herein as “SPK”), formic acid is present at 25% v/v and there is 20% w/v citric acid.

The subject invention also provides methods for inhibiting the growth of pathogenic fungi, oomycetes, and bacteria comprising applying the pesticide composition, as defined herein, to one or more species of fungus, oomycete, or bacteria.

In another embodiment, the subject invention contemplates methods of suppressing the development and activity of nematodes by applying the pesticidal composition to at least one species of nematode.

In a further embodiment, the subject invention comprises a method of controlling at least one species of weeds.

Advantageously, by applying formic acid (and/or acetic acid) in combination with citric acid (and/or certain other acids), the pesticidal utility of formic acid and/or acetic acid can be significantly improved.

The compositions of the subject invention are advantageous because they are effective and inexpensive and are readily degraded to nontoxic inorganic residues such as water and carbon dioxide.

Further, the subject invention can be applied in nearly every market currently or historically using methyl bromide, which will no longer be available for soil fumigation. This can significantly reduce the financial loss incurred as a result of the removal of methyl bromide from the market.

### BRIEF DESCRIPTION OF DRAWINGS

FIG. 1 shows the effect of formic acid application concentrations on soil pH (measured immediately after application).

FIG. 2 shows soil pH recovery after the application of formic acid for Nettle sand from Thomas produce farm.

FIG. 3 shows soil pH recovery after application of formic acid for Riviera sand from SK3 farm.

FIG. 4 shows the effect of citric acid application at different concentrations on soil pH (measured immediately after application).

FIG. 5 shows soil pH recovery after application of citric acid for Nettle sand from Thomas Produce farm.

FIG. 6 shows soil pH recovery after application of citric acid for Riviera sand from SK3 farm.

FIG. 7 shows the effect of different formulations of formic acid and citric acid (application rate at 0.5% in soil) on the pH of Nettle sand from Thomas Produce farm (measured immediately after application).

FIG. 8 shows the effect of different formulations of formic acid and citric acid (application rate at 0.5% in soil) on the pH of Riviera sand from SK3 farm (measured immediately after application).

FIG. 9 shows the effect of SPK at different application rates on soil pH (measured immediately after application).

FIG. 10 shows soil pH recovery after SPK application for Nettle sand from Thomas Produce farm.

FIG. 11 shows soil pH recovery after SPK application for Riviera sand from SK3 farm.

FIG. 12 illustrates materials and main steps for using a nylon membrane bag (NMB) assay. 12A: Nylon membrane; 12B: Dialysis closure; 12C: Prepared nylon membrane bags; 12D: Placement of pathogen inoculum into nylon membrane bags; 12E: Closure of nylon membrane bags containing pathogen inoculum; 12F: Burying of nylon membrane bags into chemical-treated soil in a Magenta vessel; and 12G: Rinsing outside of nylon membrane bags with running deionized water after removal from soil and before plating the contents onto a growth medium.

FIG. 13 shows growth of Streptomyces scabies on STR medium after a 72-h exposure to untreated soil (left) or soil amended with acetic acid (200 mM in water component of soil, right) using a nylon membrane bag (NMB) assay. The soil was a sandy-loam soil from a commercial potato field in Ontario, Canada. Note that viable S. scabies was recovered from nylon membrane bags in untreated soil with minimal contamination while essentially all S scabies was killed in treated soil.

FIG. 14 shows growth of spores and mycelium of Fusarium oxysporum f. sp. lycopersici (FOL) on PDA medium after a 72-h exposure to soil amended with SPK using a nylon membrane bag (NMB) assay. The soil was a sandy, siliceous, hyperthermic, Arenic, and Glossaqualf soil from a vegetable field in Florida, USA. A: Growth of FOL mycelium plugs in the treatments: A-1, Untreated control; A-2, 500 mg SPK kg⁻¹ soil; A-3, 1000 mg SPK kg⁻¹ soil; A-4, 1500 mg SPK kg⁻¹ soil; B: Growth of FOL spores in the treatments: B-1, Untreated control; B-2, 500 mg SPK kg⁻¹ soil; B-3, 1000 mg SPK kg⁻¹ soil; B-4, 1500 mg SPK kg⁻¹ soil. Note that FOL was recovered from the nylon membrane bags with minimum contamination.

FIG. 15 shows growth of Ralstonia solanacearum (race 1, biovar 1; tomato strain Rs5) on PDA medium after a 72-h exposure to soil amended with SPK using a nylon membrane bag (NMB) assay. The soil was a sandy, siliceous, hyperthermic, Arenic, and Glossaqualf soil from a vegetable field in Florida, USA. A: Untreated control; B: 500 mg SPK kg⁻¹ soil; C: 1000 mg SPK kg⁻¹ soil, and D: 1500 mg SPK kg⁻¹ soil. Note that R. solanacearum was recovered from the nylon membrane bags with minimum contamination.

FIG. 16 shows dose response of Sclerotinia sclerotiorum, Rhizoctonia solani, Sclerotium rolfsii, Verticillium albo-atrum, Colletotricum acutatum, Pythium myriotilum, Phytophthora capsici, Fusarium oxysporum, Phytophthora nicotianae, and Pythium apanidermatum to SPK concentrations from 0 to 0.3% for most fungi and from 0.00 to 0.12% for P. nicotianae and P. aphanidermatum that were the most sensitive to SPK.

FIG. 17 shows dose response of Root-knot nematode egg hatch to SPK concentration. The concentration necessary to kill 50% (EC₅₀) and 90% (EC₉₀) of J2 nematodes was 0.202% and 0.212% respectively. Percent mortality data was corrected using the Abbott's formula to adjust for unhatched eggs and J2 inactivity.

FIG. 18 shows effect of SPK in weed germination experiment 1 (FIG. ′8) experiment 2 (FIG. 19). Lower concentrations were used in the second experiment which was repeated once with similar results.

FIG. 19 shows effect of SPK in weed germination experiment 1 (FIG. ′8) experiment 2 (FIG. 19). Lower concentrations were used in the second experiment which was repeated once with similar results.

FIG. 20 shows SPK tested in microplots inoculated with root-knot nematodes (front) and inoculated with Phytophthora capsici (hack). Parameters being evaluated are: plant height, weeds, phytotoxicity, Phytophthora blight.

FIG. 21 shows effect of SPK concentrations in weed germination in greenhouse experiment.

FIG. 22 shows effect of SPK on nutsedge emergence in microplots that received one drench application of 500 ml of each SPK concentration.

FIG. 23 shows effect of SPK on Phytophthora blight development on pepper plants (cv. Enterprise) in microplots. Three grams of Phytophthora capsici-colonized wheat kernels were used as inoculum. Treatment received a drench of 500 ml of SPK at concentration from 0 to 20% or 500 ml of water (non-inoculated non-treated) a day after inoculation and four days before transplanting one month old pepper plants. No clear effect of phytotoxicity was observed. Disease data for graph was taken 6 weeks after transplanting. Scale used for disease development was: 0-5: 0=no disease; 1=stem constriction or lesion visible; 2=1+lower leaves defoliated; 3=1+2+upper leaves defoliated or flaccid; 4=most leaves flaccid or abscised and 5=dead plant. The experiment was run once and each treatment had 7 replications.

FIG. 24 shows effect of SPK on tomato plant height inoculated with root-knot nematode in greenhouse experiment where 80 ml of SPK was applied to the soil after application of nematode (Meloidogyne javanica) eggs. Pots were covered with plastic for 5 days and one month old tomato seedlings were transplanted. Phytotoxicity symptoms as necrotic spots in leaf borders were observed after the third day only in the two highest concentrations.

FIG. 25 shows the effect of SPK application on seed germination of tomato in Nettle sand soil (The concentrations were percentage of active intergradient in soil, w/w).

FIG. 26 shows the effect of SPK on the germination and growth of tomato in SPK treated Nettle sand soil. The seeds of tomato were sowed into the SPK treated soil after day 0*(measured immediately after treatment), 1, 3, 7, 14 and 21 days of the treatment. The concentrations of SPK were percentage of active intergradient in soil. The pictures were taken at week 5 after treatment.

FIG. 27 shows the effect of SPK application on seed germination of pepper in Nettle sand soil. The concentrations were percentage of SPK active intergradient in soil (w/w).

FIG. 28 shows the effect of SPK on the germination and growth of pepper in SPK treated Nettle sand soil. The seeds of pepper were sowed into the SPK treated soil after day 0, 1, 3, 7, 14 and 21 of the treatment. The concentrations of SPK were percentage of active intergradient in soil. The pictures were taken at week 5 after treatment.

### DETAILED DISCLOSURE

The subject invention provides environmentally-friendly materials and methods for controlling difficult to control pests, including, but not limited to, nutsedges and other monocot and dicot weeds; plant pathogenic fungi, oomycetes, and bacteria, including but not limited to Phytophthora capsici, Fusarium, and Ralstonia; and nematodes.

In specific embodiments, the subject invention provides environmentally-friendly pesticidal compositions comprising:
a. an active ingredient component comprising at least one of formic acid and acetic acid, and/or salts thereof; and
b. a second acidic component, which further potentiates the activity of the active ingredient. The potentiating acid may be, for example, citric acid, malic acid, oxalic acid, sulfuric acid, hydrochloric acid, or any combination thereof.

In preferred embodiments, the first component consists of formic acid and the second component consists of citric acid. The two ingredients function differently, with the first as a pesticidally/fungicidally/herbicidally effective ingredient and the second conditioning the efficiency of the first one.

A preferred embodiment of the subject invention, referred to herein as “SPK,” comprises formic acid and citric acid. Preferably, the concentrated formulation contains about 15% v/v to about 50% v/v of formic acid and about 10% w/v to about 40% w/v of citric acid. Considering various factors including soil acidifying ability, water solubility and economic costs, a preferred composition of SPK comprises about 25 ml formic acid and about 20 g citric acid in every 100 ml of concentrate.

In alternative embodiments, formic acid can be partially or entirely replaced by acetic acid, but a weaker pesticidal strength can be expected. Citric acid can be also entirely or partially replaced by other organic acids such as malic acid and oxalic acid, and inorganic acids such as sulfuric acid and hydrochloric acid, but these organic acids produce less acidity than citric acid, which typically results in less pesticidal effectiveness. Inorganic acids are not preferred because they have little buffering capacity; thus, they can acidify soil quickly but last only a very short time. Also, they often cause destruction of soil minerals.

The composition of the subject invention can comprise any solvent that is compatible with the active ingredient component and acidic component as well as the soil, such as water, organic solvents including ethanol, or a mixture thereof. The composition can further comprise other formulation ingredients, such as carriers/matrices where the acids can be contained, surface active substances, and stabilizers. The carriers/matrices can be, for example, polymers, gels, capsules, and slow release adjuvants.

As used herein, the term “comprising” further contemplates scenarios in which the composition and/or method “consists of” or “consists essentially of” the recited components and/or steps. As used herein, reference to “consists essentially of” refers to the situation where additional components and/or steps are only those that do not affect the pesticidal activity of the composition and/or method.

The subject invention also provides methods of making the pesticide composition. In one embodiment where water is used, the composition is prepared and stored using the following method, which is not intended to be limiting in any manner: to prepare 100 ml of stock solution, weigh 20 g of solid citric acid and then add 50 ml of water, stirring (or other aiding methods) to completely dissolve the citric acid; add 20 ml of formic acid and mix; make the volume 100 ml by adding water. In one embodiment, the composition can then be transferred into a brown container with an air-tight lid/cap and stored in a dry place away from any fire sources. In one embodiment, the composition is refrigerated in order to minimize decomposition of formic acid. The composition of the subject invention may also be prepared and stored using other doses and approaches as long as the final product is pesticidally effective as described herein.

The formulated SPK can be used as is or diluted to desired concentrations before application. The percentage of SPK in the diluted composition applied on soil is referred to herein as “application concentration,” or “concentration.” The “application rate” can be calculated determined in accordance with the concentration.

Soil pH can be reduced to 4-5, or less, following SPK application, depending on the buffering capacity of the soil and application rate of the compositions. The soil pH after application is preferred to be 4-5 for almost all soil types. Accordingly, the application rate of SPK can be determined, as less pesticide is needed for soil with a small buffering capacity and higher application rate for soil with a large buffering capacity. Preferably, an application concentration of 0.5-0.75% SPK comprising 25% v/v formic acid and 20% w/v citric acid is sufficient to achieve the desired pH range. However, other concentrations for different formulations can also be used in accordance with the disclosure herein.

The subject invention can be used for pesticidal applications, including, but not limited to: soil treatments for vineyards, fruit and nut-bearing trees, nurseries, ornamentals, floriculture, vegetables, and soil fumigation for crops in general. It can be also used for post-harvest storage fumigation, import and quarantine applications, structural fumigation and wood treatment.

Advantageously, the compositions of the subject invention can be applied in a manner that is familiar to producers of commodities that currently employ soil fumigations. The compositions can be sprayed on or injected in the treated soil. Advantageously, the compositions of the subject invention can be used without significant effects of phytotoxicity when applied at relatively low application rate at least 3 days before transplanting or seed-sowing of crop plants takes place. Thus, for example, the yield of a desirable plant is not reduced. Preferably the composition is applied at least 7-10 days before seed-sowing.

One embodiment of the subject invention is a method of controlling fungi, oomycetes and/or bacteria. This method comprises applying the pesticide composition, as defined above, to one or more species of fungus, oomycete, and/or bacterium. Examples of the target fungi, oomycetes and bacteria include Fusarium oxysporum f sp. lycopersici (FOL), Phytophthora capsici, Pythium aphanidermatum, Pythium myriotilum, Fusarium oxysporum, Sclerotinia sclerotiorum, Sclerotium rolfsii, Colletotrichum acutatum, Verticillium albo-atrum, Phytophthora nicotiana, Rhizoctonia solani and Ralstonia solanacearum.

In another specific embodiment, the subject invention is used to suppress the development and activity of nematodes by applying the composition to at least one species of nematode. The nematode species may be, for example, Meloidogyne incognita and Meloidogyne javanica.

In yet another embodiment, the subject invention provides a method of suppressing the growth of at least one species of weeds, such as purple nutsedge, pigweeds, goosegrass, sicklepod, yellow nutsedge, crabgrass, hyssop spurge, sida, cupid's shaving brush, Florida pusley, ragweed and nighshade.

The materials and methods of the subject invention are further illustrated in the following examples, in a non-limiting manner.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

### Example 1

### Effects of Formic and Citric Acid on pH Changes of Major Soil Types in South Florida

The optimal ratio of formic acid and citric acid and the application rate of SPK (best combination of formic and citric acid) for different type of soils were evaluated. The soils used in this study are Nettle sand from Thomas Produce farm (sandy, siliceous, hyperthermic, ortstein Alfic Arenic Haplaquods); Riviera sand from SK3 farm (loamy siliceous, hyperthermic, Arenic Glossaqualfs). The latter is calcareous, with much greater buffering capacity for pH change than the former soil type. Formic acid, citric acid or mixtures of both were incubated in the soil and soil pH changes were measured with time and rate.

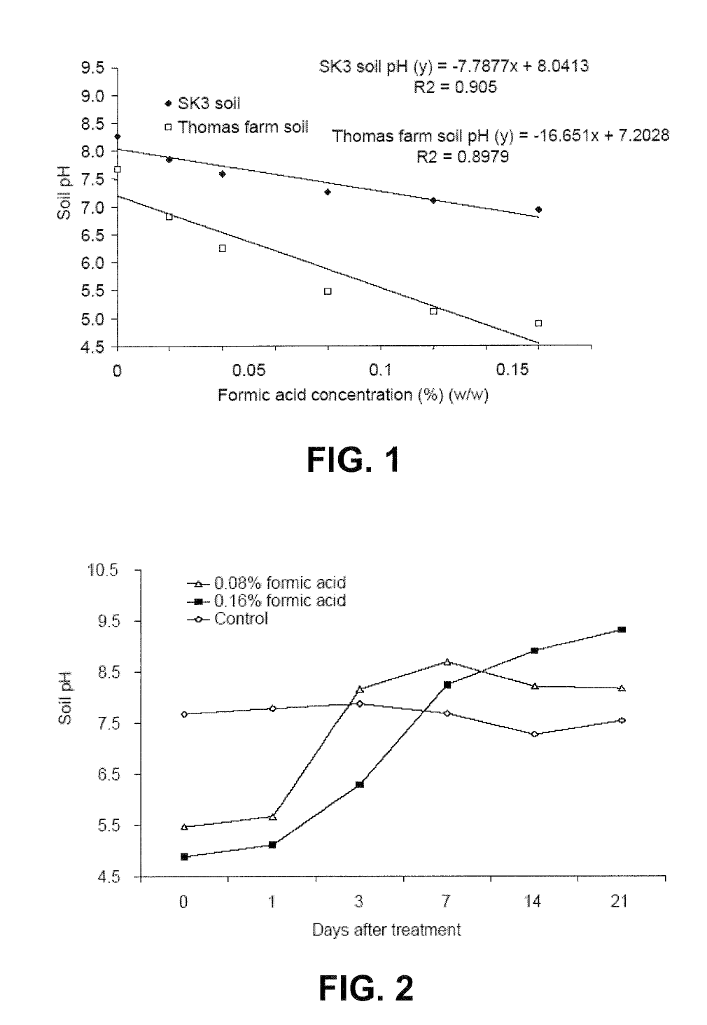

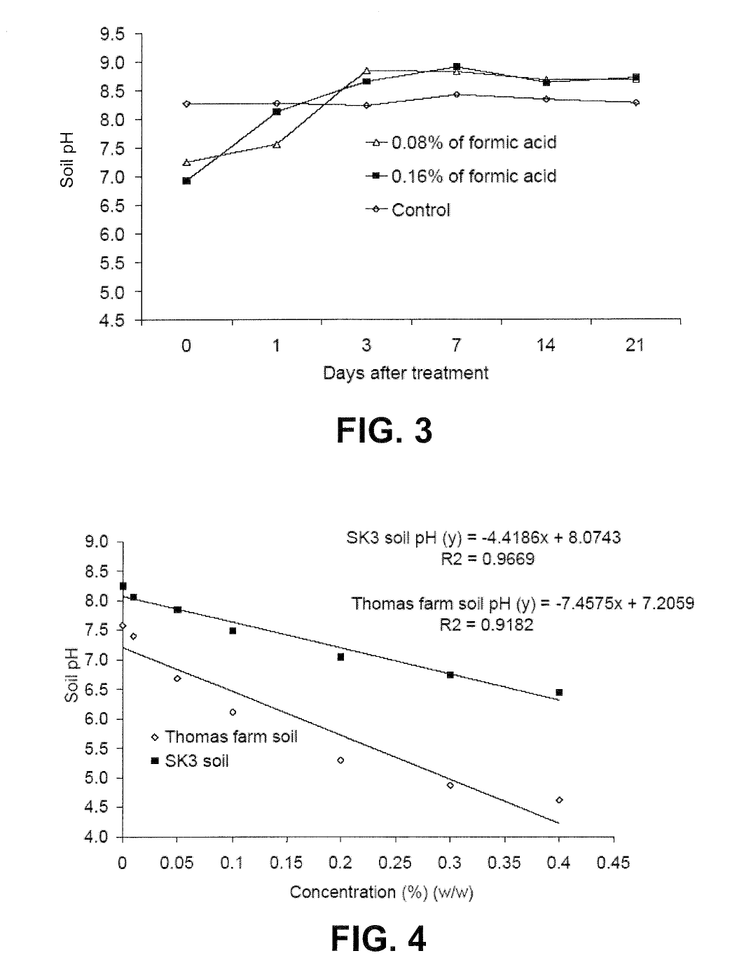

It was observed that soil pH decreased linearly with the application rate of formic acid, but the change rate (slope of the regression line) varied significantly between the two soils (FIG. 1). Soil with small buffering capacity, such as Nettle sand from Thomas farm, had more pH decrease. Soil pH recovered with time elapse after formic acid application (FIG. 2), but the time required for the pH recovery back to the original varied with application rate and between the two soils (FIGS. 2 and 3). For the same soils, higher application rate resulted in longer recovery time (FIG. 2); whereas high pH soil with a large buffering capacity recovered more rapidly (FIG. 3).

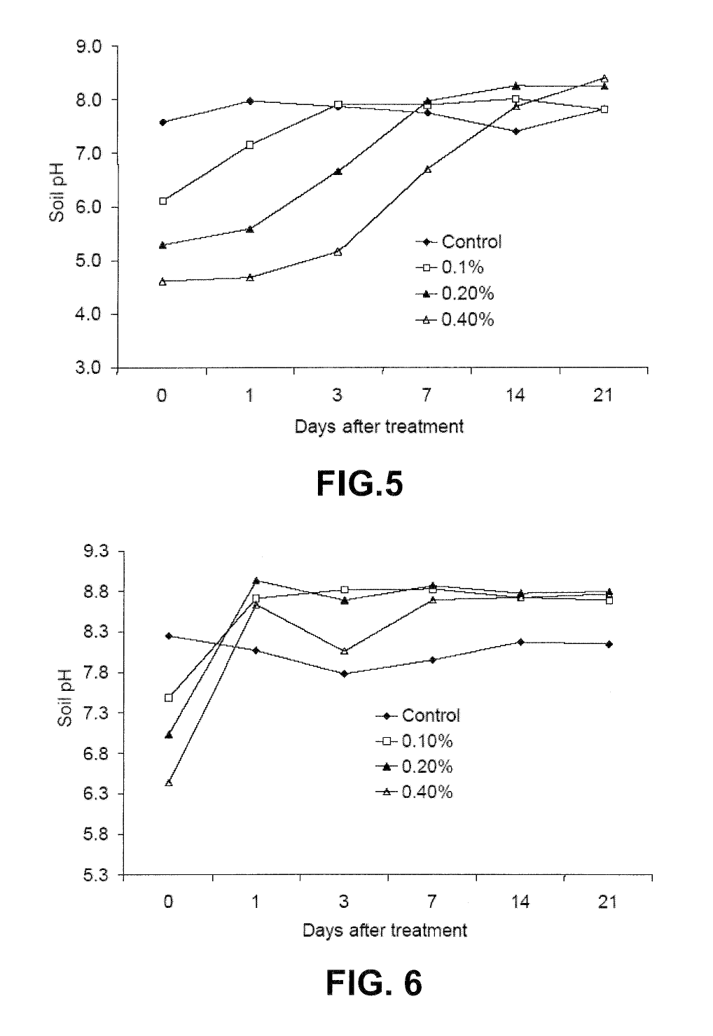

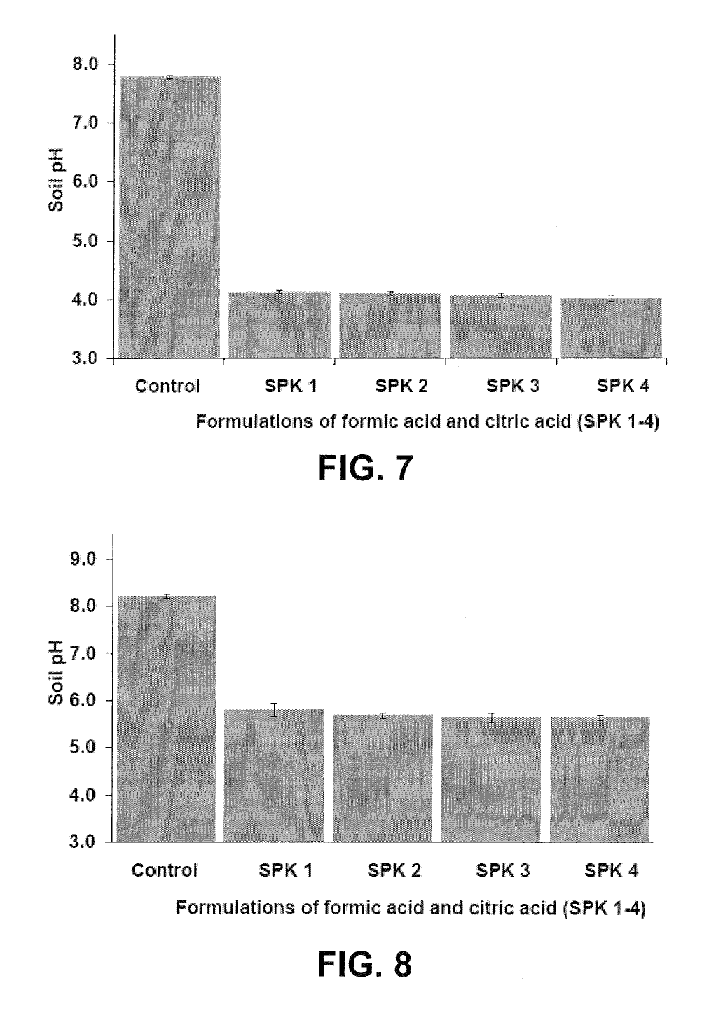

The effects of citric acid on soil pH were less than formic acid, but with similar characteristics (FIGS. 4-6). The effects of formic acid-citric acid mixtures with various proportions (Table 1) on soil pH are shown in FIGS. 7 and 8. Increasing the proportion of formic acid in the mixture slightly decreased soil pH regardless of soil type (FIGS. 7 and 8). Based on the above results and also considering water solubility and economic costs, a composition of SPK with 25 ml formic acid and 20 g citric acid in 100 ml is considered to be optimal and was used for further tests.

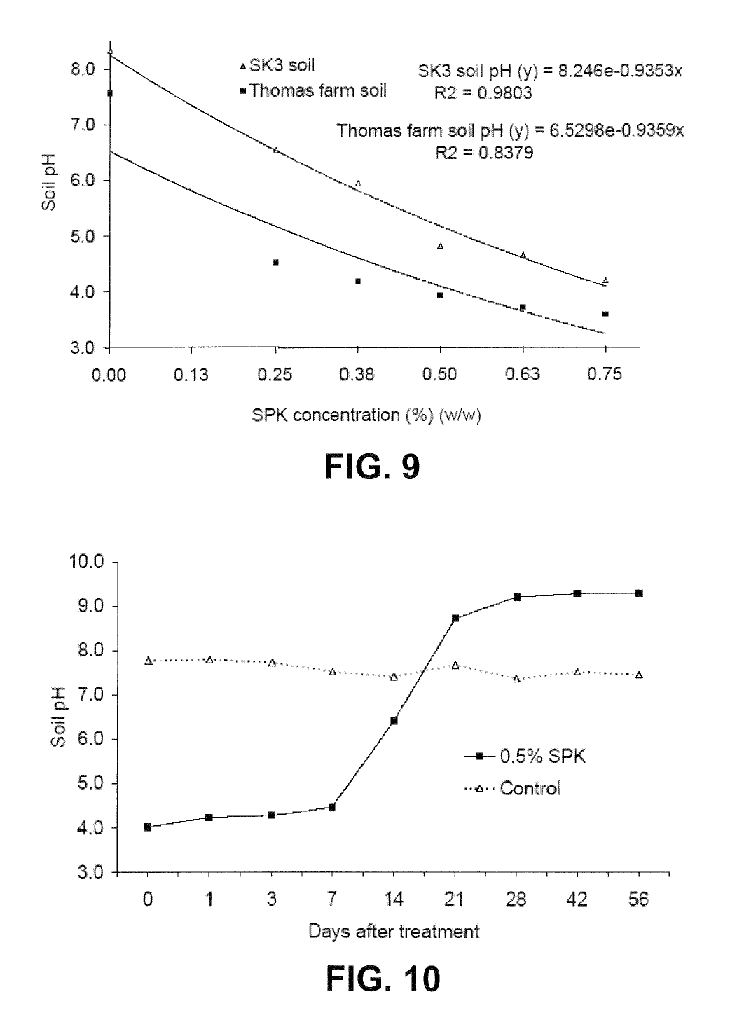

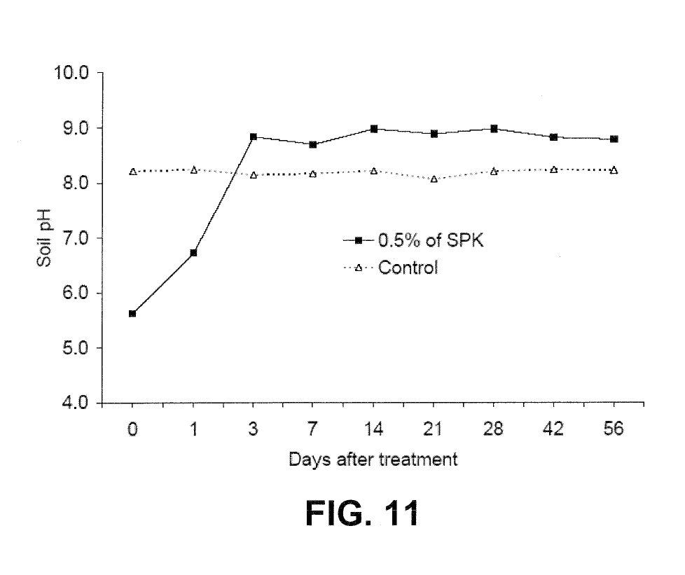

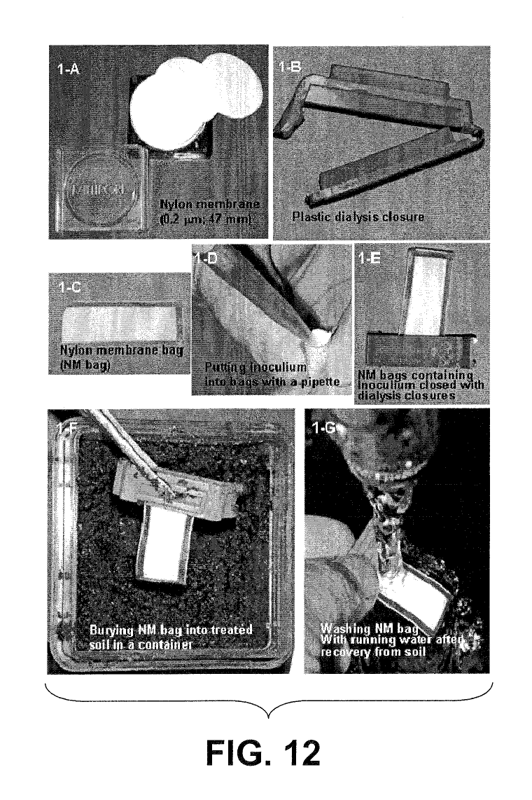

The effect of SPK on pH of representative soils is shown in FIGS. 9-11. A concentration range of 0.5-0.75% appears sufficient to reduce soil pH to 4.0-5.0, for killing soil borne plant pathogens, with the low end for soil with a small buffering capacity (such as the soil from Thomas farm) and the high end for soil with a large buffering capacity (such as the soil from SK3 farm). After SPK treatment, soil pH tends to recover to original pH or higher (FIGS. 10 and 11), which is normal. It took less than three days for the pH to recover in a calcareous soil (FIG. 11) but 18 days in the Nettle sand soil with a small buffering capacity (FIG. 10), indicating that less SPK is needed for the small buffering capacity soil.

TABLE 1
Formula of the pesticide compositions

| | Formic acid | Citric acid | Water |
|---|---|---|---|
| SPK formula | (ml/100 ml) | (g/100 ml) | (ml/100 ml) |
| 1 | 12 | 38 | 50 |
| 2 | 16 | 34 | 50 |
| 3 | 20 | 30 | 50 |
| 4 | 25 | 25 | 50 |

### Example 2

### Composition

A pesticidal formula was prepared having the ingredients as shown below:

TABLE 2
A formula of the pesticide composition

| Ingredients | Concentration | |
|---|---|---|
| Formic acid | 25% | v/v |
| Citric acid | 20% | w/v |

In the following examples, SPK was prepared in water according to Example 2.

### Example 3

### A Nylon Membrane Bag Assay for Determination of the Effect of Chemicals on Soilborne Plant Pathogens in Soil

The effects of four chemicals (acetic acid, benomyl, streptomycin sulfate, and SPK) on three soilborne pathogens (Streptomyces scabies, Ralstonia solanacearum, and Fusarium oxysporum f. sp. lycopersici) were tested using a nylon membrane bag (NMB) assay.

### Materials and Methods

Soils. Soil was collected from a 0-15 cm depth from a commercial potato field in Ontario, Canada (site G) and from a vegetable field in St. Lucie County, Fla. USA (site F). Site G soil was a sandy loam with a pH of 7.1 and organic carbon content of 1.2%. Site F soil was sandy, siliceous, hyperthermic, Arenic, and Glossaqualf with a pH of 7.6 and organic carbon content of 9.06 g kg⁻¹ soil. Soils were air-dried, passed through a 2-mm sieve, and stored at room temperature (24° C.) prior to use. The water content of the soils was adjusted to 10% by adding deionized water before the soils were treated with chemicals.

Preparation of Streptomyces scabies inoculum. A virulent soilborne plant pathogenic bacterium, Streptomyces scabies strain SP, isolated from soil in Ontario, Canada (Conn et al. 1998) was used in this study. Spores from 2-week-old cultures grown on yeast malt extract (YME) agar medium were scraped off the plates into sterile deionized water. Viability of spores after exposure to soil:chemical mixtures was determined by culturing on Streptomyces (STR) medium (Conn et al., 1998).

Preparation of Fusarium oxysporum f. sp. lycopersici inoculum. A virulent soilborne plant pathogenic fungus, Fusarium oxysporum f. sp. lycopersici (FOL), race 3, isolated from an infected tomato plant in a field in St. Lucie County, Fla., was used in this study. The culture of FOL was grown on potato dextrose agar (PDA) medium (39.0 g of potato dextrose agar powder, 1.0 L of water) for 10 to 15 days. Agar plugs were cut out of the cultures with a core borer (1.0 cm in diameter). The culture plugs were completely dried by airflow in a Safeair class II safety cabinet for 12 to 24 h until they were thin-dried plugs. Viability of spores and mycelia of FOL after exposure to soil:chemical mixtures was determined by culturing on PDA medium.

Preparation of Ralstonia solanacearum inoculum. A virulent soilborne plant pathogenic bacterium, Ralstonia solanacearum (race 1, biovar 1; tomato strain Rs5), isolated in Quincy, Fla. (Pradhanang and Momol, 2001; Pradhanang et al., 2005) was used in this study. Ralstonia solanacearum was grown at 28° C. either on casamino acid peptone glucose (CPG) agar medium (peptone 10 g, casamin acids 1 g, dextrose 2.5 g, agar 15 g, deionized water 1 liter) for 48 hours or in CPG broth on a shaker (200 rpm) for 18 h (overnight) (Pradhanang et al., 2005). Bacterial cells were suspended in sterile deionized water and the concentration of inoculum was estimated by measuring absorbance at 590 nm. Viability of R. solanacearum after exposure to soil:chemical mixtures was determined by culturing on PDA medium.

Chemicals. Chemicals added to soils included acetic acid (Glacial, 99.8%, Fisher Scientific), a broad spectrum antimicrobial chemical that can kill soilborne plant pathogens (Conn et al., 2005; Tenuta et al., 2002); benomyl (methyl 1-(butylcarbamoyl) benzimidazol-2-ylcarbamate) (BENLATE 50% WP; DuPont, Wilmington, Del.), a broad spectrum systemic fungicide (Edgington, et al., 1971); streptomycin sulfate (Sigma, St. Louis, Mo., USA), an aminoglycoside antibiotic for controlling bacterial diseases of crops (McManus et al., 2002); and SPK. The nylon membrane bag assay was used to test toxicity of acetic acid against S. scabies, benomyl against FOL, streptomycin against R. solanacearum, and SPK against both FOL and R. solanacearum. The concentration of acetic acid used was 200 mM in the water component of the soil. To achieve this, 0.5 ml acetic acid (4.2 M) was added to 99.5 g soil giving a final moisture content of 10%. The concentrations of benomyl used were 500, 1000, and 1500 mg kg⁻¹ soil; streptomycin sulfate were 200, 400, 800, and 1500 mg kg⁻¹ soil; and SPK were 500, 1000, and 1500 mg kg⁻¹ soil.

Construction of nylon membrane bags. Nylon membrane bags (8×30 mm) were made of Millipore nylon hydrophilic membrane filter discs (0.2 μm pore size and 47 mm in diameter, Millipore Corporation, Billerica, Mass.) and dialysis closures (23 mm width, Spectrum Laboratories, Inc) (FIGS. 12A and 12B). A round nylon membrane disc was first folded in half, and then sealed to become a rectangle bag using an electron bag sealer (Daigger Lab Supplies, Vernon Hills, Ill.). One of the two short-side edges was left unsealed (open) (FIG. 12C).

Nylon membrane bag assay procedure. Effect of the various chemicals on S. scabies, FOL, and/or R. solanacearum was determined by the nylon membrane bag (NMB) assay. The procedure involved: 1) Cell suspensions (200 uL) of S. scabies or R. solanacearum; or air-dried culture plugs (consisting of mycelia and spores) or spore suspensions (200 uL) of FOL were placed into nylon membrane bags (FIG. 12D), completely sealing the bags with dialysis closures (FIG. 12E), and storing in a refrigerator at 10° C. prior to use. 2) Water content of the soil was adjusted to 10% by adding deionized water and weighing soil samples into Magenta GA-7 vessels (Carolina Biological Supply Company, Burlington, N.C.), 150 g soil per vessel. 3) The soils in the Magenta vessels were treated with the chemicals at the designed concentrations and mixed well. 4) The NM bags containing inoculum were immediately buried into soil in the Magenta GA-7 vessels (FIG. 12F) and the vessels with contents were incubated in the lab at room temperature (24° C.) for 72 hours. 5) The nylon membrane bags were removed from the soil in the Magenta GA-7 vessels after 72 hours and rinsed with tap water first, then deionized water (3 minutes each rinse) (FIG. 12G). Any soil particles or other debris attached to the nylon membrane bags were removed by brushing the bags with a soft brush during the rinse. 6) The culture plugs of FOL in the NM bags were transferred onto PDA medium under a Safeair class II safety cabinet with forceps. The spores of S. scabies and FOL and cells of R. solanacearum in the NM bags were recovered by cutting the washed nylon membrane bags into small pieces and placing them in test tubes under a Safeair class II safety cabinet, then adding sterile water to the test tubes to suspend them. After a serial dilution made with sterile deionized water, the spores of S. scabies were spread on STR medium (Conn et al., 1998) and spores of FOL and cells of R. solanacearum were spread on PDA medium. 7) The recovered inocula of S. scabies, FOL, and R. solanacearum on the media were incubated at room temperature for 3-7 days for determining their viability. 8) The toxicity of chemicals on the pathogens in the soils was finally evaluated according to the viability and growth of the pathogens on the media. The experiments were conducted twice. For S. scabies, three nylon membrane bags were placed into each of three magenta vessels for each experiment. For FOL and R. solanacearum there were three nylon membrane bags for each experiment. The significant difference of the data was analyzed by a t test. Also, statistical regression analysis of data was conducted.

### Results

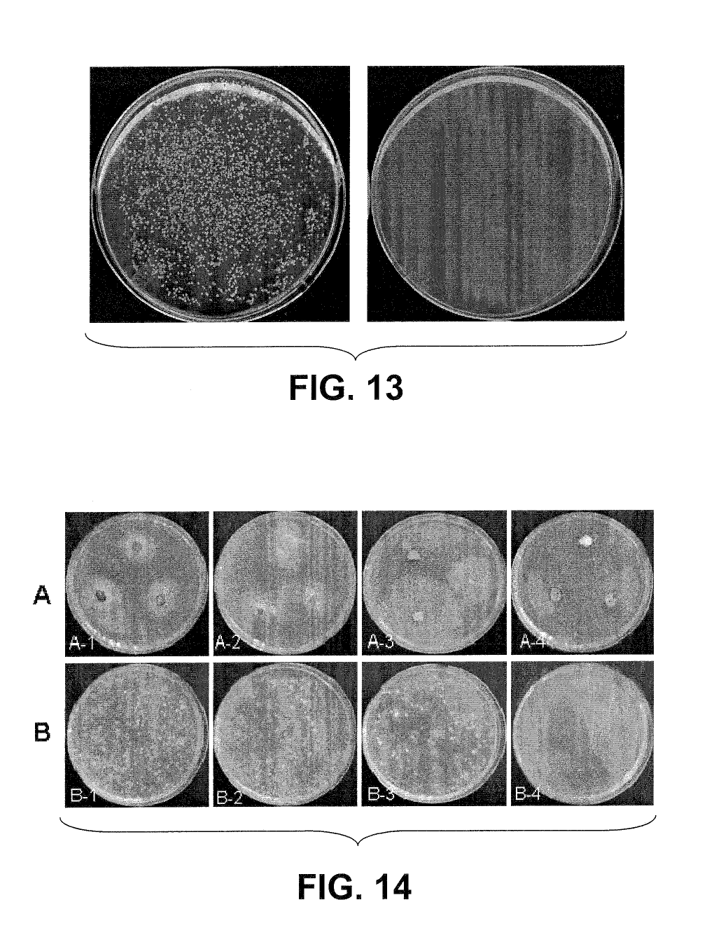

Effect of acetic acid on Streptomyces scabies in soil. A 72-h exposure of S scabies to acetic acid in soil resulted in almost 100% death (Table 3, FIG. 13). Very little microbial contamination resulted from the NM bag assay as seen in FIG. 13 where mainly only S. scabies colonies grew from the control treatment and almost nothing grew from the acetic acid treatment.

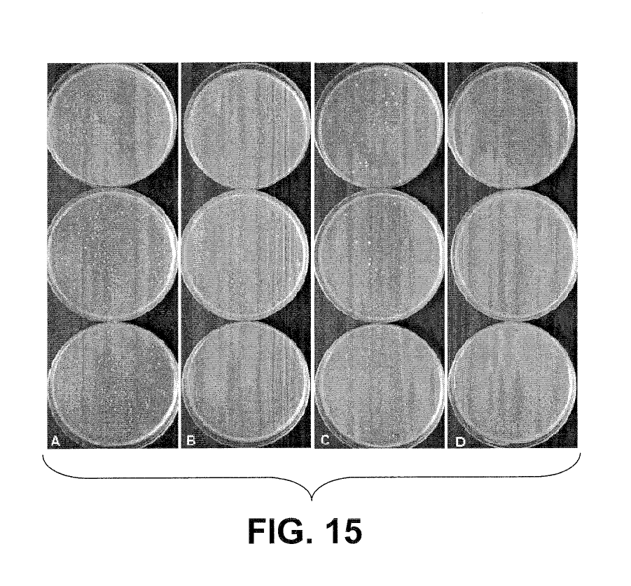

Effect of SPK on Fusarium oxysporum f. sp. lycopersici and Ralstonia solanacearum in soil. After a 72-hour incubation, SPK at the concentration of 1500 mg kg⁻¹ soil killed 83.3% of FOL mycelium (Table 4), 100% of FOL spores (Table 4), and 97.2% of R. solanacearum cells (Table 5) in the NM bags placed in soil. SPK at 1000 mg kg⁻¹ soil killed 50% FOL mycelium (Table 4), 68.2% FOL spores (Table 4), and 12% of R. solanacearum (Table 5). SPK at 500 mg kg⁻¹ did not kill FOL mycelium or spores (Table 4) or R. solanacearum (Table 5). Representative plates showing growth of FOL and R. solanacearum from these treatments can be seen in FIGS. 14 and 15, respectively. Very little microbial contamination resulted from the NM bag assay as seen in FIGS. 14 and 15 where mainly only FOL, R. solanacearum, or nothing grew from the treatments. The effects of different SPK concentrations on FOL and R. solanacearum in the soil were significantly different (t test, p=0.01). The regression equation of FOL spore mortality (y) and the SPK concentration (x) was y=7.525x2-0.975x−11.525 (R²=0.9334), while the regression equation of FOL mycelium mortality (y) and the SPK concentration (x) was y=8.325x2-11.635x−0.025 (R²=0.9555) and the regression equation of Ralstonia mortality (y) and the SPK concentration (x) was y=21.088x2-75.163x+57.263 (R²=0.969).

Effect of BENLATE on Fusarium oxysporum f. sp. lycopersici in soil. After a 72-hour incubation BENLATE at the concentrations of 500 to 1500 mg kg⁻¹ soil did not kill the mycelia (mycelium plugs) of FOL (Table 4), but reduced the growth rate of FOL mycelia. The average colony diameter of FOL in untreated controls was 3.3±0.4 cm, while those treated with 500, 1000, and 1500 mg kg⁻¹ soil were 2.3±0.6 cm, 2.3±0.4 cm, and 2.2±0.4 cm, respectively (n=6). BENLATE killed spores of FOL in soil. The mortalities of spores of FOL caused by BENLATE at the concentrations of 500, 1000, and 1500 mg kg⁻¹ soil were 39.4%, 49.3%, and 50.4%, respectively. Like in the SPK treatments with FOL, very little microbial contamination resulted from using the NM bag assay in the BENLATE treatments (photos not shown). Statistical analysis (t test) indicated that the mycelium growth rates between the control and BENLATE treatments were significantly different at p=0.05, but not among the different BENLATE concentrations. Also, FOL spore mortality between the control and the BENLATE treatments in the soil was significantly different (p=0.05), but not among the different BENLATE concentrations. The regression equation of the FOL spore mortality (y) and the BENLATE concentration (x) was y=37.653 Ln(x)+4.8589 (R²=0.9118). However, the regression equation of FOL mycelium mortality (y) and the BENLATE concentration (x) was y=4.684 Ln(x)+0.4535 (R²=0.1137).

Effect of streptomycin on Ralstonia solanacearum in soil. The toxicity of streptomycin on R. solanacearum increased with its concentration in soil after a 72-hour exposure (Table 5). The highest mortality, 75.3%, of R. solanacearum occurred in the soil treated with 1500 mg kg⁻¹ soil streptomycin, whereas treatments with 800, 400, and 200 mg kg⁻¹ soil of streptomycin resulted in a mortality of 21%, 11.9%, and 0.9%, respectively. Like in the SPK treatments with R. solanacearum, very little microbial contamination resulted from using the NM bag assay in the streptomycin treatments (photos not shown). The mortality of R. solanacearum among the control and treatments of streptomycin at concentrations ranging from 400-1500 mg kg⁻¹ soil was significantly different (t test, p=0.01), but not between the control and the treatment of streptomycin at the 200 mg kg⁻¹ soil concentration (p=0.05). The regression equation of the R. solanacearum mortality (y) and the streptomycin concentration (x) in soil was y=7.45x2-27.57x+22.7 (R²=0.9585).

TABLE 3
Effect of acetic acid on growth of Streptomyces scabies using a nylon
membrane bag assay in soil^{a}

| Treatments | Number of colonies | Mortality (%) |
|---|---|---|
| Trial I | | |
| Untreated | 11000 ± 1400 | — |
| Acetic acid | 27 ± 17 | 99.8 |
| Trial II | | |
| Untreated | 33000 ± 3000 | — |
| Acetic acid | 0 ± 0 | 100 |

^{a}Three nylon membrane bags containing Streptomyces scabies were placed into each of three Magenta vessels containing untreated soil or soil amended with acetic acid (200 mM in water component of soil). The soil was a sandy-loam soil from a commercial potato field in Ontario, Canada. The bags were removed after 72 hours and plated onto STR medium. Number of colonies are means ± standard error (n = 9). This experiment was done twice and data from the two trials shown separately.

TABLE 4
Effect of BENLATE and SPK on growth of spores and
mycelium of Fusarium oxysporum f. sp. lycopersici
using a nylon membrane bag assay in soil^{a}

| | Number of | | | |
|---|---|---|---|---|
| | viable mycelium | | | |
| | plugs/number | Mycelium | Number of | Spore |
| | of mycelium | mortality | colonies from | mortality |
| Treatments | plugs tested | (%) | spores | (%) |
| Untreated | 6/6 | 0.0 | 245000 ± 45000 | 0.0 |
| Benlate | | | | |
| (mg kg⁻¹ soil) | | | | |
| 500 | 6/6 | 0.0 | 148500 ± 15000 | 39.4 |
| 1000 | 5/6 | 16.7 | 124000 ± 7000 | 49.3 |
| 1500 | 6/6 | 0.0 | 121500 ± 3500 | 50.4 |
| SPK | | | | |
| (mg kg⁻¹ soil) | | | | |
| 500 | 6/6 | 0.0 | 240800 ± 28900 | 1.7 |
| 1000 | 3/6 | 50.0 | 177900 ± 11500 | 68.2 |
| 1500 | 1/6 | 83.3 | 0 | 100.0 |

^{a}Three nylon membrane bags containing spores or mycelium of F. oxysporum f. sp. lycopersici were placed into Magenta vessels containing untreated soil or soil amended with benlate or SPK. The soil was a sandy, siliceous, hyperthermic, Arenic, and Glossaqualf soil from a vegetable field in Florida, USA. The bags were removed after 72 hours and plated onto PDA medium. Number of colonies are means ± standard error from two experiments (n = 6).

TABLE 5
Effect of streptomycin sulfate and SPK on growth of Ralstonia
solanocearum (race 1, biovar 1; tomato strain Rs5) using
a nylon membrane bag assay in soil^{a}

| Treatments | Number of colonies | Mortality (%) |
|---|---|---|
| Untreated | 258000 ± 32600 | — |
| Streptomycin (mg kg⁻¹ soil) | | |
| 200 | 256000 ± 16500 | 0.9 |
| 400 | 227000 ± 78100 | 11.9 |
| 800 | 204000 ± 82900 | 21.6 |
| 1500 | 63800 ± 42300 | 75.3 |
| SPK (mg kg⁻¹ soil) | | |
| 500 | 236200 ± 11800 | 0.85 |
| 1000 | 227300 ± 12800 | 12.0 |
| 1500 | 7200 ± 5200 | 97.2 |

^{a}Three nylon membrane bags containing Ralstonia solanacearum (race 1, biovar 1; tomato strain Rs5) were placed into Magenta vessels containing untreated soil or soil amended with streptomycin sulfate or SPK. The soil was a sandy, siliceous, hyperthermic, Arenic, and Glossaqualf soil from a vegetable field in Florida, USA. The bags were removed after 72 hours and plated onto PDA medium. Number of colonies are means ± standard error from two experiments (n= 6).

### Example 4

### Activity Against Soil Borne Fungi

In vitro studies have been conducted on Phytophthora capsici, Pythium aphanidermatum, Pythium myriotilum, P. nicotianae, Fusarium oxysporum, Sclerotinia sclerotiorum, Sclerotium rolfsii, Colletotrichum acutatum, Verticillium albo-atrum and Rhizoctonia solani to determine the dose response and IC₅₀ of SPK using a simple media-amendment approach.

A 0.7 cm diameter plug of a 4-6 day old culture of the different fungal isolates were transferred to Petri plates with ¼-strength potato dextrose agar containing a range of SPK concentrations from 0 to 0.3% or 0 to 0.5%. Fungal radial growth was measured after the 3^{rd}, 6^{th}, and 9^{th} day of incubation at 26° C. under continuous light. Percent inhibition was calculated based on radial growth of two replicate experiments combined and IC₅₀ values were calculated using the Probit SAS procedure. The experiments were designed as a randomized complete block with three replicates and each experiment/dose range was done twice.

Sigmoid, sigmoidal 3 parameter probability model (1) and 95% confidence bands were computed using Sigma Plot 10 (systat software Inc., Point Richmond, Calif., USA) for each pathogen/compound combination.

Probit analysis was performed to infer the SPK concentration required to reduce mycelial growth by 50% (IC₅₀) and 90% (IC₉₀) using SAS probit procedure (SAS Institute Inc., Cary, N.C., USA).

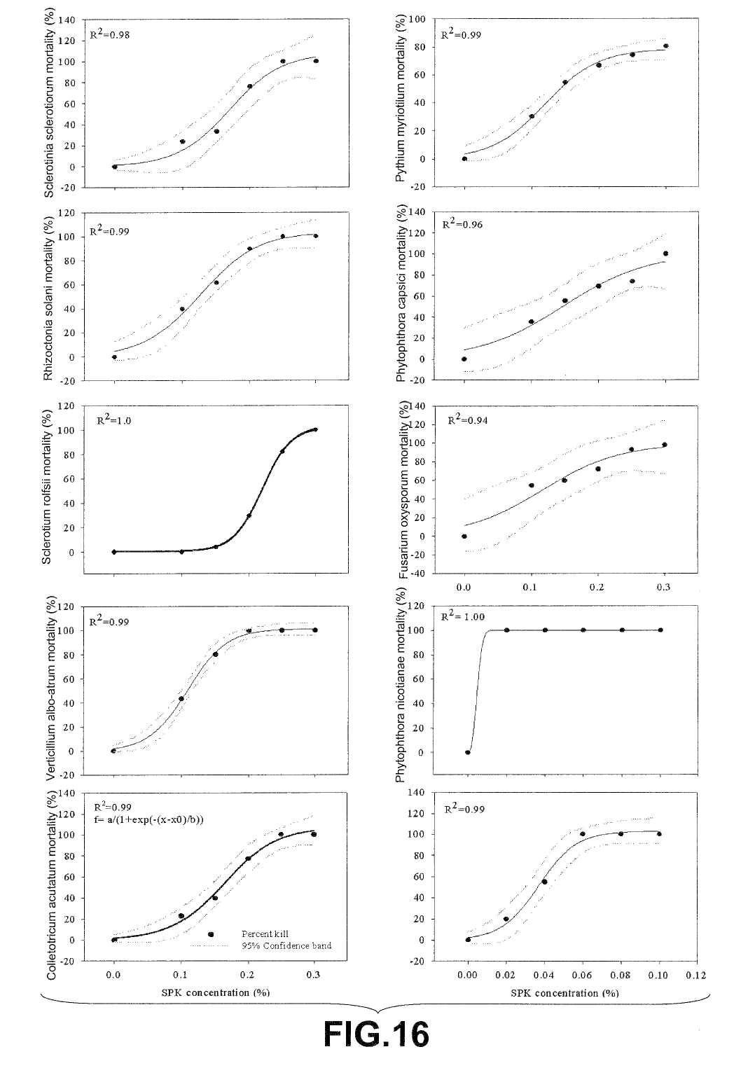

It was found that increasing concentrations of SPK significantly increased inhibition rates of all fungi and most oomycetes tested, Pythium aphanidermatum and Phytophthora nicotiana were the most sensitive to SPK and lower concentrations were needed for probit analysis and calculation of IC₅₀'s (Table 6 and FIG. 16). Results against fungi in vitro showed that SPK concentration between 0.12 and 0.22% were enough to suppress 50% of mycelial growth and between 0.20 to 0.43% to suppress 90%.

TABLE 6
Estimated parameters for nonlinear regression of soil-borne pathogen mortality
percentages on the concentration of SPK (%) required to control 50% (IC₅₀) and
90% (IC₉₀) mycelial growth in vitro at 28° C. after 6 days or 3 days (
Pythium. aphanidermatum and Phytophthora. nicotianae).

| | | IC₅₀ | | | IC₉₀ | | |
|---|---|---|---|---|---|---|---|
| | | Lower | | Upper | Lower | | Upper |
| Pathogens | R² | limit^{a} | | limit^{a} | limit^{a} | | limit^{a} |
| Rhizoctonia solani | 0.99 | 0.11 | 0.12 | 0.13 | 0.18 | 0.20 | 0.22 |
| Colletotrichum acutatum | 0.99 | 0.14 | 0.15 | 0.15 | 0.21 | 0.23 | 0.25 |
| Sclerotinia sclerotiorium | 0.98 | 0.14 | 0.15 | 0.16 | 0.22 | 0.23 | 0.26 |
| Verticillium albo-atrum | 0.99 | 0.10 | 0.11 | 0.11 | 0.15 | 0.16 | 0.17 |
| Sclerotium rolfsii | 1.00 | 0.01 | 0.22 | 0.22 | 0.25 | 0.26 | 0.28 |
| Fusarium oxysporum | 0.94 | 0.12 | 0.13 | 0.14 | 0.22 | 0.25 | 0.29 |
| Phytophthora capsici | 0.96 | 0.12 | 0.14 | 0.15 | 0.28 | 0.31 | 0.38 |
| Phytopthora nicotianae | 1.00 | — | — | — | — | — | — |
| Pythium aphanidermatum | 0.99 | 0.03 | 0.03 | 0.03 | 0.05 | 0.05 | 0.06 |
| Pythium myriotylum | 0.99 | 0.13 | 0.15 | 0.16 | 0.35 | 0.43 | 0.60 |

^{a}Confidence internval estimates (p < 0.001)

### Example 5

### Inhibition of Soilborne Fungi

SPK was tested in vitro for the control of Phytophthora capsici, Pythium aphanidermatum, P. myriotilum, Fusarium oxysporum, Sclerotinia sclerotiorum, Sclerotium Colletoirichum acutatum, Verticillium albo-estrum, and Rhizoctonia solani.

A 0.7 cm diameter plug of a 4-6 day old culture of the different fungal isolates were transferred to Petri plates with ¼-strength potato dextrose agar containing a range of SPK day of incubation at 26° C. under continuous light. Complete inhibition of mycelial growth of P. aphanidermatum and V. albo-atrum occurred at an SPK concentration of 0.2%, S. sclerotiorum, P. capsici, R. solani and C. acutatum at 0.3%, and P. myriotilum and S. rolfsii at 0.4%-0.5%. Hence, two additional experiments were carried out, one with SPK concentrations of 0.0, 0.1, 0.2, 0.3, 0.4 and 0.5% (Exp. 1) and another with SPK concentrations of 0.0, 0.1, 0.15, 0.20, 0.25 and 0.30% (Exp. 2). Three replications per fungus for each SPK concentration were included in each experiment and each experiment was performed twice. Inhibition was calculated based on radial growth of two replicate experiments combined and IC₅₀ values were calculated using the Probit analysis for toxicology separately for each range of concentrations. A summary of IC₅₀ values for both experiments and the nine fungi is shown in Table 7.

TABLE 7
IC₅₀ of nine soilborne fungi exposed to a range of SPK concentrations
between 0 and 5% (Exp. 1) and 0 and 3% (Exp. 2). Values are based
on two experiments using each of the two ranges of concentrations.
IC₅₀

| Fungus | Exp. 1 | Exp. 2 |
|---|---|---|
| Colletotrichum. acutatum | 0.19 | 0.16 |
| Fusarium oxysporum | 0.16 | 0.14 |
| Rhizoctonia. solani | 0.14 | 0.14 |
| Verticillium. albo-atrum | 0.10 | 0.12 |
| Sclerotinia sclerotiorum | 0.22 | 0.16 |
| Sclerotium rolfsii | 0.21 | 0.21 |
| Phytophthora. capsici | 0.14 | 0.16 |
| Pythium. aphanidermatum | 0.05 | 0.05 |
| Pythium. myriotilum | 0.18 | 0.16 |

### Example 6

### Activity Against Nematodes

SPK has also been tested against root knot nematode egg hatch in vitro, and against nematode activity.

Meloidogyne incognita eggs were extracted from tomato (cultivar Tiny Tim) roots maintained in the greenhouse. Roots were cut into 1 cm pieces, shaken in a sealed nalgene flask with a 10% bleach solution (10 ml bleach and 90 ml tap water) for 2.5 min., and poured through 180, 45, and 25 μm mesh sieves. Nematode eggs were collected on the 25 μm sieve and rinsed into a beaker. The concentration of nematode eggs/ml was determined using a nematode counting slide with the target concentration of 1000 eggs/ml.

SPK concentrations from 0 to 2% in 0.2% increments were tested making 11 treatments with three replications each. Experiments were performed in a darkened, sterilized laminar flow hood, where water plus the corresponding SPK amount was added to Petri plates to make 15 ml and 2 ml of nematode eggs and agitated briefly. Egg viability was assessed daily for 4 days taking 2 ml of solution (after brief agitation) and placed into nematode counting slide. The number of eggs, live J2, and dead J2 were counted for each treatment/replication and the experiment was done twice.

A second experiment was set up testing lower SPK concentrations from 0 to 0.04% to have better data for EC₅₀ calculations. Dose response and probit analysis was performed based on percentage dead and live J2. Percent mortality data was corrected using the Abbott's formula to adjust for unhatched eggs and J2 inactivity.

Corrected % killed=((% alive control−% alive treated)/(% alive control))×100%.

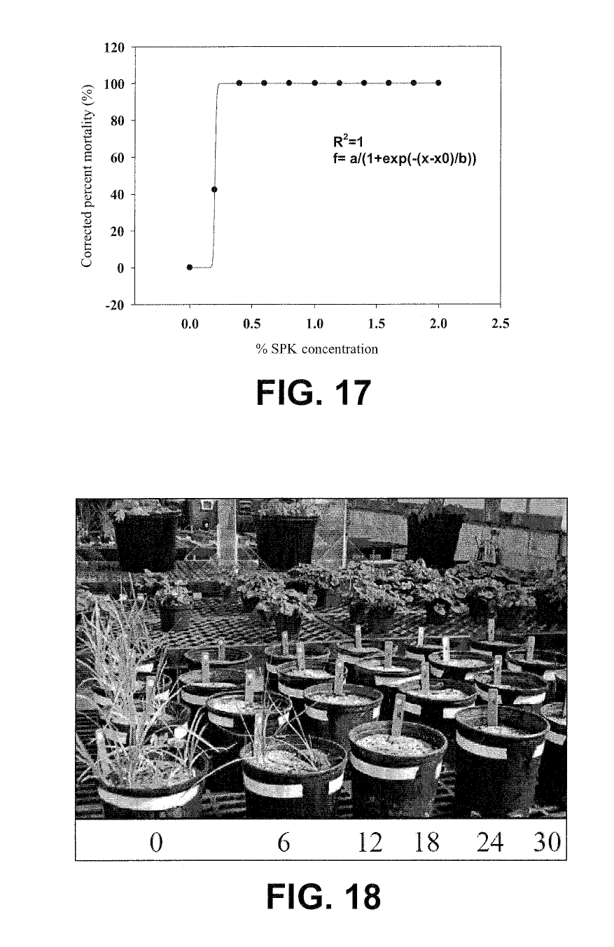

Results showed that in vitro similar concentration as the ones needed for fungal mycelia was needed (0.2 to 0.4%) to suppress root knot nematode egg hatch (FIG. 17).

### Example 7

### Weed Suppression

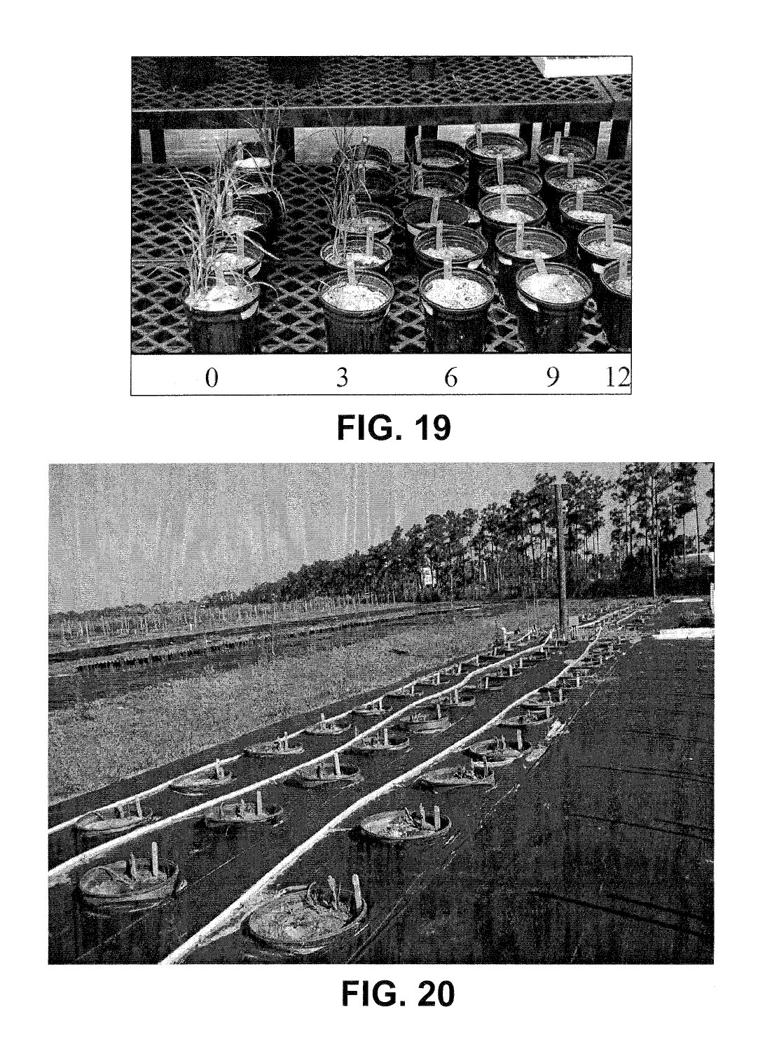

Furthermore, SPK has been tested against weed suppression in greenhouse (FIGS. 18 and 19) and in microplot studies (FIG. 20).

Five SPK concentrations of 0, 3, 6, 9, or 12 were applied (100 ml) to one gallon pots containing 100% sand. One day before application of the treatment the following weeds were planted to the pots: 6 purple nutsedge, 6 yellow nutsedge, 12 pigweed, 20 goosegrass and 10 sicklegpod. Weed emergence was evaluated 8 days after treatment. Percent germination by species was calculated and means were subject to statistical analysis using SAS.

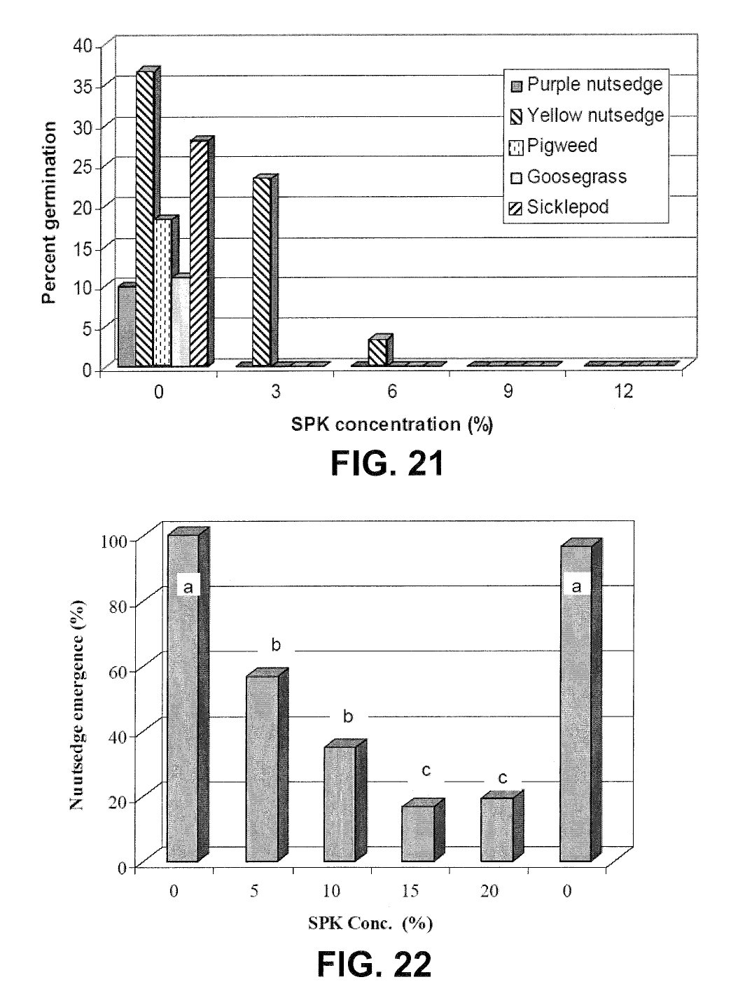

SPK was shown to be also very effective for weed suppression in the greenhouse and also in microplots with higher concentrations. In the greenhouse, a SPK concentration of 3% was enough to suppress purple nutsedge, pigweed, goosegrass and sicklepod and 6% significantly suppressed germination of yellow nutsedge (FIG. 21). In microplots 5% SPK significantly reduced Yellow nutsedge germination compared to the control (FIG. 22). In addition also in micro plots an SPK concentration of 5% significantly reduced presence of weeds (crabgrass, goosegrass, hyssop spurge, sida, cupid's shaving brush, Florida pusley, ragweed and nightshade) when evaluated all together (Table 8).

TABLE 8
Effect of SPK in weeds on microplots planted with tomato and pepper.

| | Tomato^{x} | | Pepper^{x} | |
|---|---|---|---|---|
| | Fresh | Dry | Fresh | Dry |
| SPK treatment | weight^{y} | weight^{y} | weight^{y} | weight^{y} |
| (%) | (g) | (g) | (g) | (g) |
| Non-Inoc.-Non-Treated | 70.09a | 9.61a | 63.77a | 10.31a |
| Inoc. Non-treated | 50.73ab | 7.27ab | 40.25ab | 9.36a |
| 5 | 23.19bc | 3.63bc | 45.10ab | 4.49a |
| 10 | 18.58bc | 2.69bc | 35.55ab | 6.5a |
| 15 | 3.83c | 1.77c | 15.49ab | 2.61a |
| 20 | 8.41c | 1.15c | 6.56b | 0.98a |

However, when the most abundant weeds were evaluated separately, 15% SPK significantly reduced numbers of goosegrass in tomato microplots and crabgrass in pepper microplots (Table 9).

TABLE 9
Effect of SPK on number of crabgrass and goosegrass (most abundant
weeds) by treatment in microplots planted with tomato and pepper.

| SPK treatment | Tomato^{x} | | Pepper^{x} | |
|---|---|---|---|---|
| (%) | Crabgrass^{y} | Goosegrass^{y} | Crabgrass^{y} | Goosegrass^{y} |
| Non-Inoc.-Non-Treated | 26.86a | 23.86a | 29.00a | 7.14a |
| Inoc. Non-treated | 26.29a | 30.29ab | 8.85b | 3.71a |
| 5 | 13.57a | 10.14ab | 18.00ab | 5.71a |
| 10 | 13.00a | 7.14ab | 20.28ab | 2.14a |
| 15 | 7.57a | 3.43b | 10.85b | 6.86a |
| 20 | 11.14a | 2.43b | 14.85ab | 6.14a |

### Example 8

### Effect on Phytophthora Blight

SPK has also been tested against Phytophthora blight of peppers in greenhouse experiments and in microplots studies.

In the greenhouse trials, P. capsici-inoculated and non-inoculated soil was treated with 40 ml of 0, 2.5, 7.5, 10.0 and 12.5% SPK solution. Pots were tarped and kept in the greenhouse for 5-7 days. Tarps were removed and two-week-old peppers were transplanted into treated soil. Pots were placed over saucers with water in the greenhouse benches at 28° C. Disease was evaluated starting at the fifth day and every three days up to 20^{th} day. Three replications for each treatment were included and the experiment was done twice. Plant height and weight data of two experiments were combined and analyzed using SAS procedure.

It was consistently observed that 10% concentration of SPK was enough to suppress Phytophthora blight of pepper (Table 10).

TABLE 10
Inoculated and non-inoculated pepper (Enterprise) treated with a range
of SPK concentrations from 0 to 15% in green house experiment. Means
followed by the same letter are not significantly different (p < 0.05).
Experiment was repeated twice, table shows averages of three
experiments. Numbers followed by same letter are not significantly
different (Ducan p = 0.05).

| | P. capsici inoculated | | Non-inoculated | |
|---|---|---|---|---|
| SPK | Plant | Plant | Plant | Plant |
| application | Height | Weight | Height | Weight |
| rate (%) | (cm) | (g) | (cm) | (g) |
| 0 | — | — | 14.00a | 8.04a |
| 2.5 | — | — | 15.00a | 8.52a |
| 5.0 | — | — | 14.33a | 8.49a |
| 7.5 | — | — | 15.66a | 8.44a |
| 10.0 | 10.0a | 3.10a | 15.67a | 6.04b |
| 12.5 | 7.00a | 1.57b | 14.00a | 5.19bc |
| 15.0 | 6.00a | 0.95b | 11.66a | 3.96c |

The SPK concentrations tested for microplots studies were 0, 5, 10, 15, 20% plus one non-inoculated non-treated control making six treatments with seven replications each. In this experiment, Phytophthora capsici infested wheat kernels (3 g/microplot) were used to inoculate 35 microplots leaving seven non-inoculated for the non-inoculated/non-treated control. Inoculum was spread in the middle of the microplot at 1-2 inches deep. SPK treatments were applied to the corresponding treatment/concentrations and microplots were covered with polyethylene plastic. Four days later, plastic was removed and two one-month old pepper seedlings (Enterprise) were transplanted in each microplot. Pepper plants were watered with an automated system twice a day. Disease evaluation was started five days later and repeated weekly.

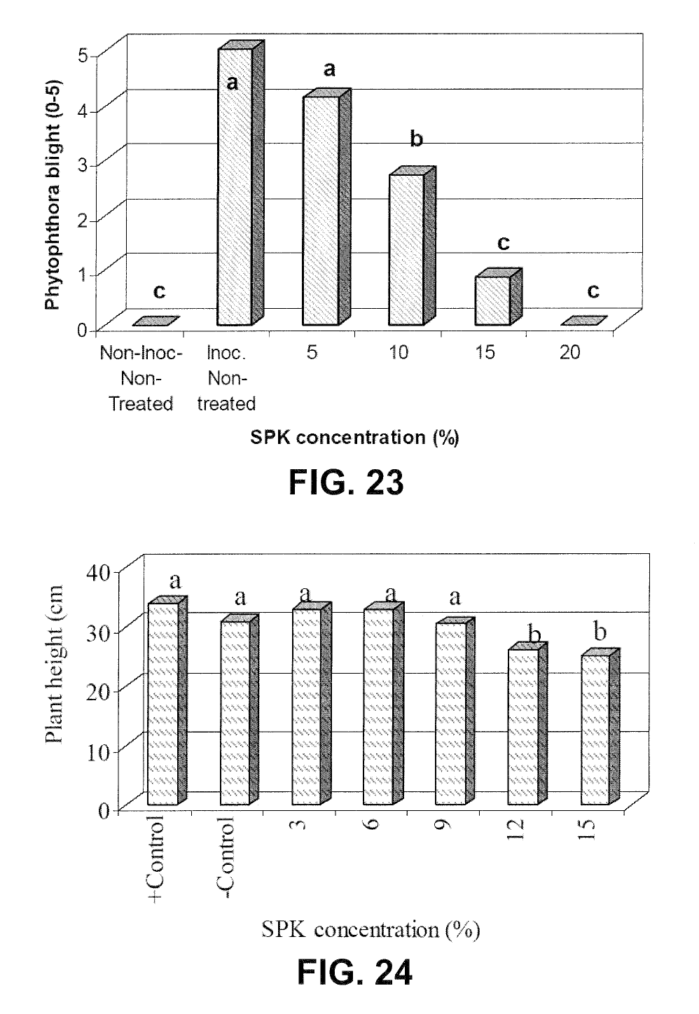

In microplots studies, 10% SPK also significantly reduced Phytophthora blight of peppers (FIG. 23).

### Example 9

### Inhibition Of Phytophthora Capsici

In a further study, a 0.7 cm diameter plug of a 4-6 day old culture of Phytophthora capsici was transferred to Petri plates containing ¼ potato dextrose agar and a range of SPK concentrations from 0 to 1%. Radial growth was measured after the 3^{rd}, 6^{th}, and 9^{th} day of incubation at 26° C. under continuous light. Complete inhibition of growth of P. capsici occurred at concentrations of 0.4% SPK incorporated into culture medium. Consequently, an additional experiment was carried out, with SPK concentrations of 0, 0.1, 0.2, 0.3, 0.4 and 0.5%. Three replications for each SPK concentration were included and the experiment was performed twice. Inhibition was calculated based on radial growth and IC₅₀ values were calculated using probit analysis for toxicology. The average IC₅₀ value for P. capsici was 0.15%. In greenhouse trials, P. capsici-inoculated and non-inoculated soil was treated with 30 ml of 0, 2.5, 7.5, 10.0 and 12.5% SPK solution. Pots were tarped and kept in the greenhouse for seven days. Tarps were removed and two-week-old peppers were transplanted into treated soil. Chlorosis in plants treated with the 12.5% solution and stunting with all concentrations of SPK was observed. However, in inoculated plants, Phytophthora blight did not occur starting at a 10.0% SPK concentration and surviving plants resumed normal growth. The experiment was repeated with four-week-old pepper transplants with similar results.

### Example 10

### Effect of SPK on Crop Germination and Growth

The effect of SPK on seed germination and crop growth was also determined. In one greenhouse experiment, Meloidogyne javanica (15,360 eggs/ml) eggs were inoculated into 30 pots containing 20/80 potting soil/sand and covered to avoid exposure to UV light. The next day, six SPK concentrations (0, 3, 6, 12, and 15%) were sprayed over five pots each and pots were covered with polyethylene plastic. After 5 days, plastic cover was removed and one month old tomato plants were transplanted to all pots. Approximately 60 days later, tomato plants were evaluated for gall formation. Results of tomato plant height in the greenhouse experiment are shown in FIG. 24. Significant reduction of plant height and necrotic spot in tomato leaflet's borders were observed with the 12 and 15% concentration of SPK.

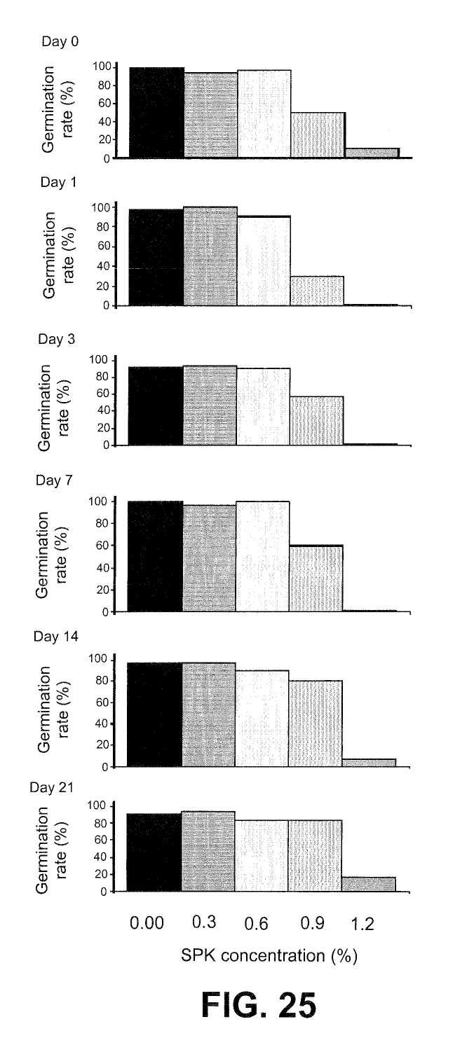

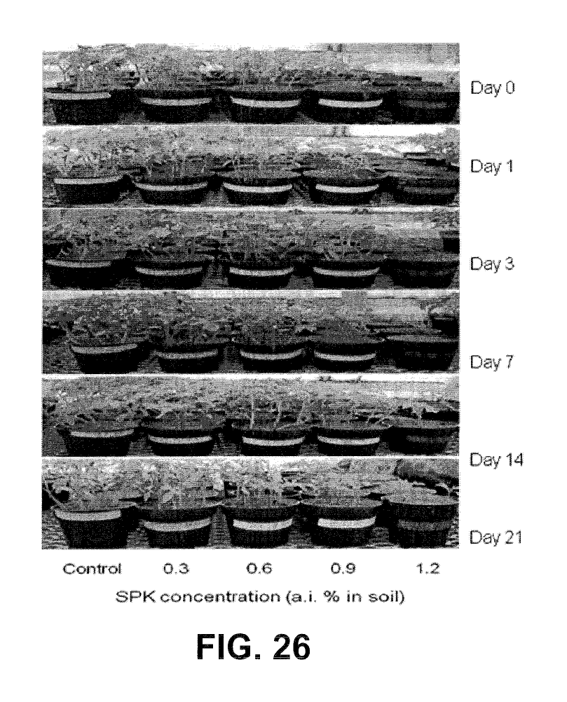

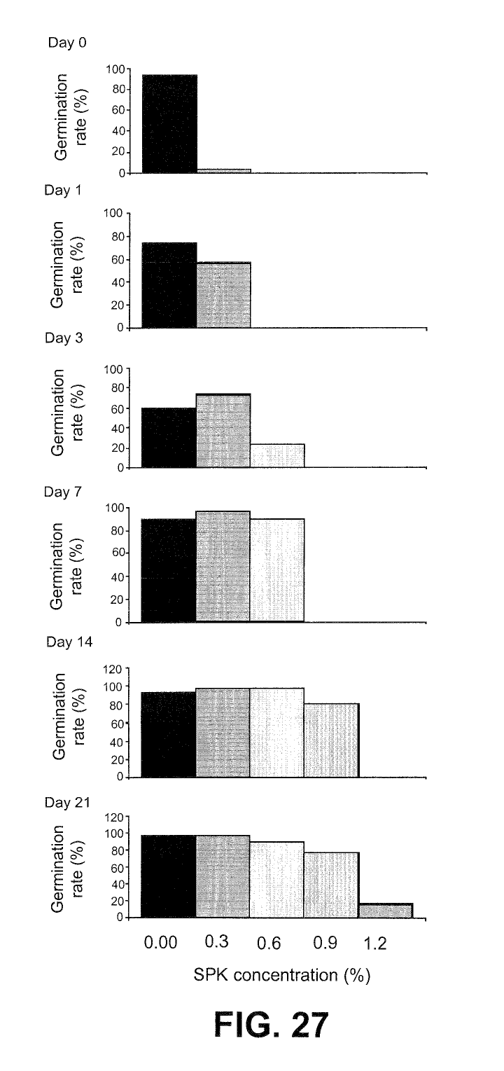

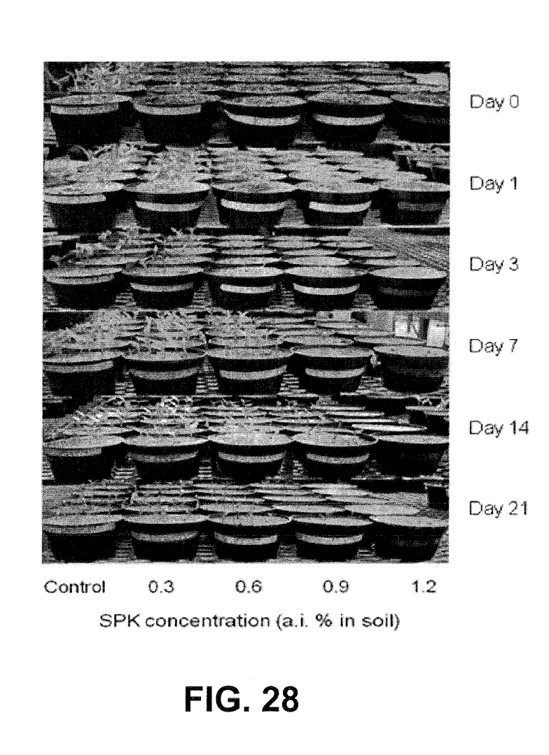

In another greenhouse pot study, the effect of SPK at various concentrations on seed germination of bell pepper and tomato was investigated using Nettle sand from Thomas Produce farm, one of the typical soils in south Florida and requiring relatively less SPK due to a small buffering capacity. Results showed that SPK had a significant effect on the germination of bell pepper and tomato. Bell pepper seemed more sensitive than tomato, particularly at concentrations higher than 0.6% (FIGS. 25-28). The effect of SPK on tomato germination was minimal if SPK concentrations were controlled at less than 0.6% (FIG. 25). If seed was sown in 7 days after SPK application, the germination and growth of tomato were similar to the control even at the SPK concentration up to 0.9% (FIG. 26). Therefore, 3-7 days of time delay are sufficient for tomato between SPK application and seed sowing. The germination of bell pepper was significantly lower than the control if the seed was sown in 1-3 days after SPK application. However, the germination rate and growth of bell pepper could be as good as the control (around 90% germination rate) if seed was sown in 7 days after SPK application (FIGS. 27 and 28). Therefore, 7 days time delay will be necessary for bell pepper in order to avoid any negative impact of SPK.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

We claim:

1. A pesticidal composition comprising:
a. an active ingredient component comprising at least one of formic acid and acetic acid, and/or salts thereof; and
b. a second acidic component, which further potentiates the activity of the active ingredient;
wherein said composition further comprises an appropriate pesticide carrier.

2. The composition according to claim 1, wherein the active ingredient component consists of formic acid in an amount between 15% v/v and 50% v/v in aqueous solution.

3. The composition according to claim 1, wherein the second acidic component consists of citric acid in an amount between 10% w/v and 40% w/v in aqueous solution.

4. The composition, according to claim 1, wherein said composition comprises 15% v/v to 50% v/v formic acid, and 10% w/v to 40% w/v citric acid.

5. The composition, according to claim 1, comprising additional pesticidal agents.

6. The composition, according to claim 1, comprising less than 2% of other pesticidal agents.

7. The composition, according to claim 1, which is an aqueous composition.

8. The composition, according to claim 1, which is an aqueous concentrate that comprises about 25 ml of formic acid and about 20 g of citric acid in every 100 ml of concentrate.

9. The concentrate, according to claim 8, which consists essentially of about 25 ml of formic acid and about 20 g of citric acid in every 100 ml of concentrate.

10. A method of controlling a pest comprising applying the composition of claim 1 to the pest or its situs.

11. The method, according to claim 10, wherein the pest is a nematode.

12. The method, according to claim 10, used to control a weed.

13. The method, according to claim 10, wherein said pest is a bacterium or fungus.

14. The method according to claim 10, wherein the composition is applied by fumigation.

15. The method according to claim 10, wherein the composition is applied by spraying or injecting into the soil.

16. A method of making a pesticidal or herbicidal composition comprising:
a. providing an aqueous solution containing least one acidic component selected from citric acid, malic acid, oxalic acid, sulfuric acid, hydrochloric acid, and any combination thereat and
b. adding water and mixing formic acid and/or acetic acid to the aqueous solution to form about 10% w/v to about 40% w/v acid, and 15% v/v to about 50% v/v formic acid and/or acetic acid in the composition.
